(19) United States
(12) Patent Application Publication
(10) Pub. No.: US 2026/0371444 A1
(43) Pub. Date: Nov. 19, 2026

(54) HEATING METHOD FOR ELECTRONIC ATOMIZER, AND ELECTRONIC DEVICE

(71) Applicant: SMOORE INTERNATIONAL HOLDINGS LIMITED, Grand Cayman (KY)

(72) Inventors: Yezhen LI, Shenzhen (CN); Xuegang YAO, Shenzhen (CN); Hu JIN, Shenzhen (CN); Chunming HUA, Shenzhen (CN)

(73) Assignee: SMOORE INTERNATIONAL HOLDINGS LIMITED, Grand Cayman (KY)

(21) Appl. No.: 19/681,371

(22) Filed: May 19, 2026

(30) Foreign Application Priority Data
May 19, 2025 (CN) 202510646343.3

(51) Int. Cl. H05B 1/02; A24F 40/46; A24F 40/53; A24F 40/57

(52) U.S. Cl. CPC H05B 1/0252; A24F 40/46; A24F 40/53; A24F 40/57

(57) ABSTRACT

A heating method for an electronic atomizer, and an electronic device are provided. The method includes heating an electronic atomizer in a first heating stage. The electronic atomizer includes a first heating element and a second heating element to heat a substrate. A heating power of at least one of the first heating element and the second heating element is reduced in a second heating stage.

### RELATED APPLICATIONS

The present application claims priority to Chinese Patent Application No. 202510646343.3 filed on May 19, 2025. The entire disclosure of the prior application is hereby incorporated by reference.

### TECHNICAL FIELD

This disclosure belongs to the technical field of electronic atomizers, including to a heating method for an electronic atomizer, and an electronic device.

### BACKGROUND

With the continuous development of technologies of electronic atomizers, the electronic atomizers can provide users with an increasing number of good experiences. For example, some electronic atomizers can simultaneously heat at least two different substrates, to provide users with a mixed mouth feel during a puff on the substrates. However, in a case that two or more different substrates are heated at the same time, the electronic atomizers may possibly generate more aerosols, and more aerosols possibly cause a health risk such as stronger addiction.

### SUMMARY

This disclosure aims to provide a heating method for an electronic atomizer, and an electronic device, which can improve the aerosol amount during heating of a plurality of substrates by the electronic atomizer.

In an aspect of this disclosure provides a heating method for an electronic atomizer, including: in a first heating stage of the electronic atomizer, using a first heating element to heat a substrate of the electronic atomizer, and using a second heating element to heat the substrate of the electronic atomizer; and reducing the heating power of at least one of the first heating element and the second heating element in a second heating stage of the electronic atomizer, where the second stage is a heating stage following the first stage after the electronic atomizer is activated.

In an example, the substrate comprises a first substrate and a second substrate; the in a first heating stage of the electronic atomizer, using a first heating element to heat a substrate of the electronic atomizer, and using a second heating element to heat the substrate of the electronic atomizer, including: in the first heating stage of the electronic atomizer, using the first heating element to heat the first substrate of the electronic atomizer, and using the second heating element to heat the second substrate of the electronic atomizer.

In an example, wherein the first heating element is configured to heat the first substrate in a first substrate-carrying unit of the electronic atomizer, and the second heating element is configured to heat the second substrate in a second substrate-carrying unit of the electronic atomizer.

In an example, the heating method for the electronic atomizer further includes: obtaining the first temperature change rate of the first heating element and the second temperature change rate of the second heating element in the first heating stage of the electronic atomizer; in a case that the first temperature change rate is less than a set temperature change threshold, and/or the second temperature change rate is less than the set temperature change threshold, the electronic atomizer enters the second heating stage.

In an example, the heating method for the electronic atomizer further includes: in a case that airflow information is detected after the electronic atomizer is activated, the electronic atomizer enters the first heating stage.

In an example, the in a first heating stage of the electronic atomizer, using a first heating element to heat a substrate of the electronic atomizer, and using a second heating element to heat the substrate of the electronic atomizer includes: using the first heating element to heat the substrate continuously for first period of time at first heating power; and using the second heating element to heat the substrate continuously for second period of time at second heating power.

In an example, the first heating power is the maximum power of the first heating element; and/or the second heating power is the maximum power of the second heating element.

In an example, the reducing the heating power of at least one of the first heating element and the second heating element in a second heating stage of the electronic atomizer includes: in a third stage, using the third heating power of the first heating element to heat the substrate, and using the fourth heating power of the second heating element to heat the substrate, where the second stage includes the third stage; the third heating power is less than the fourth heating power; and the fourth heating power is less than or equal to the second heating power.

In an example, the duration of the third stage is shorter than the duration of the first stage.

In an example, the reducing the heating power of at least one of the first heating element and the second heating element in a second heating stage of the electronic atomizer includes: after the third stage, executing a fourth stage; and in the fourth stage, using the first heating element to heat the substrate at fifth heating power, and using the second heating element to heat the substrate at sixth power, where the second stage includes the fourth stage; the fifth heating power is greater than the sixth heating power; the fifth heating power is less than or equal to the first heating power; and returning to the third stage after the fourth stage is completed.

In an example, the duration of the fourth stage is shorter than the duration of the first stage.

In an aspect of this disclosure further provides a heating apparatus for an electronic atomizer, which can implement the method provided in any embodiment of this disclosure.

In an aspect of this disclosure further provides an electronic device. The electronic device includes: a processor and a memory. The memory is configured to: store a program causing the electronic device to perform the method provided in any embodiment of this disclosure, and store data for implementing the method provided in any embodiment of this disclosure. The processor is configured to perform the program stored in the memory.

In an aspect of this disclosure further provides a non-transient computer-readable storage medium having a computer instruction stored therein. The computer instruction is used for causing a computer to perform the heating method for an electronic atomizer provided in any embodiment of this disclosure.

In the method provided in this disclosure, the heating process of the electronic atomizer is divided into stages. In the first heating stage, the first heating element and the second heating element operate at relatively high power, so that the temperatures of the first heating element and the second heating element rise rapidly. In the second stage after the first stage, the volume of aerosols can be reduced by reducing the heating power of at least one of the first heating element and the second heating element. In this way, a requirement of a user for aerosols is met, and a health risk caused by excessive aerosols can be avoided.

### BRIEF DESCRIPTION OF THE DRAWINGS

To describe the technical solutions in the embodiments of this disclosure more clearly, the following briefly introduces the accompanying drawings for describing the embodiments or the related art. Apparently, the accompanying drawings in the following description show merely some embodiments of this disclosure, and a person of ordinary skill in the art may still derive other drawings from the accompanying drawings without creative efforts.

FIG. 1 is a schematic flowchart of a heating method for an electronic atomizer provided in an example of this disclosure;

FIG. 2 is a schematic diagram of a structure of an electronic atomizer provided in an example of this disclosure;

FIG. 3 is a schematic diagram of changes in the heating power of an electronic atomizer provided in an example of this disclosure; and

FIG. 4 is a schematic diagram of a structure of a heating apparatus for an electronic atomizer provided in an example of this disclosure.

### DETAILED DESCRIPTION

In order to make the technical problems, technical solutions, and beneficial effects to be solved by this disclosure clearer, the following is a further detailed explanation of this disclosure in conjunction with the accompanying drawings and examples. It should be understood that the examples described herein are merely used to explain this disclosure but are not intended to limit this disclosure.

An electronic atomizer includes an atomization assembly. The atomization assembly is a core component of the electronic atomizer and is responsible for storing e-liquid, atomizing a heating substrate, and transferring an airflow. The atomization assembly can carry a heatable substrate. The heatable substrate may alternatively be referred to as a heating substrate or a substrate. When a user takes a puff on the electronic atomizer, the heatable substrate can be heated and atomized within the atomization assembly of the electronic atomizer, and then aerosols are generated for user inhalation. For example, an e-liquid type substrate or the heatable substrate can be contained within a container to obtain a substrate-carrying unit. A plurality of substrate-carrying units can be placed in different substrate-carrying unit chambers of the atomization assembly. By switching the substrate-carrying unit chambers located in a heating region, the e-liquid in different substrate-carrying unit chambers can be heated. For another example, a substrate strip is used as a substrate-carrying unit. A substrate can be applied and fixed onto the substrate strip which is continuously transferred to the heating region to atomize the substrate on the substrate strip. Alternatively, the substrate can be fixed to a substrate strip in another shape. By changing a relative position between the substrate strip and the heating region, the substrate fixed to the substrate strip can be heated and atomized.

In a development process of the technology of the electronic atomizer, to provide users with a better experience, the electronic atomizer has increasingly rich functions. For example, the electronic atomizer can carry various heating substrates. The various heating substrates carried by the electronic atomizer can have different flavors, so that a user can have different puffing experiences with different flavors during a puff on the electronic atomizer. Meanwhile, the user can also add a flavoring agent into the heating substrate to enhance the original flavor of the heating substrate, or to obtain a single heating substrate with a mixed mouth feel. In addition, the electronic atomizer may further heat at least one heating substrate (in this example, the substrate in each substrate-carrying unit is used as a heating substrate). When the electronic atomizer heats various heating substrates, mixed aerosols can be generated to further provide the user with diverse mixed mouth feels. However, heating the various heating substrates simultaneously will inevitably generate more aerosols, and an increase in the aerosol amount may possibly cause adverse effects on user's health.

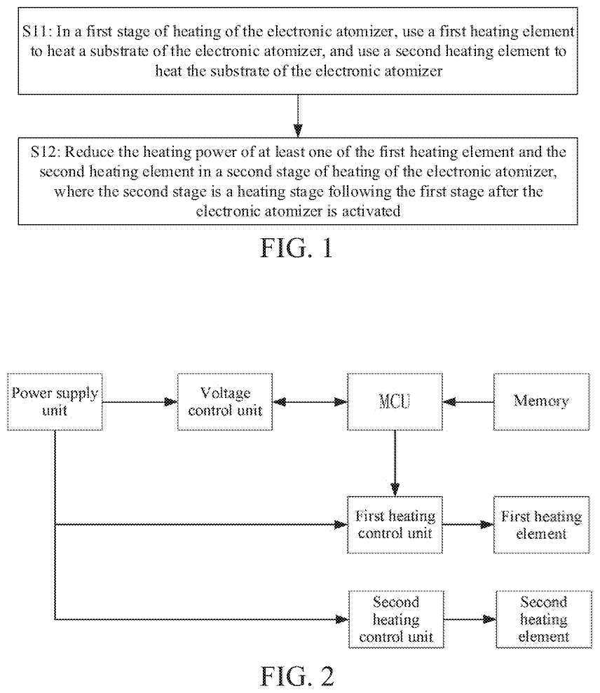

Therefore, an example of this disclosure provides a heating method for an electronic atomizer, as shown in FIG. 1, including the following steps. Step S11: In a first heating stage of the electronic atomizer, use a first heating element to heat a first substrate-carrying unit of the electronic atomizer, and use a second heating element to heat a second substrate-carrying unit of the electronic atomizer.

In an example of the present disclosure, the atomization assembly includes components such as a liquid storage cavity and a heating component. That is, each atomization assembly can be formed as an independent atomization cartridge which can perform heating and atomization once the device is powered on. In an example, the atomization assembly can include a liquid storage cavity, but does not include a heating component. In this case, the electronic atomizer can include an atomization assembly and a heating unit. When the atomization assembly is connected to the heating unit, fluid communication is implemented therebetween. That is, liquid in the atomization assembly can flow to the heating unit and be heated by the heating unit to generate aerosols.

In an example of this disclosure, the electronic atomizer includes a first heating element and a second heating element. The first heating element and the second heating element may be two mutually independent heating elements or an integrated heating element. In a case that the first heating element and the second heating element are two mutually independent heating elements, the first heating element and the second heating element can be heated respectively. A first heating circuit for the first heating element and a second heating circuit for the second heating element may be configured inside the electronic atomizer. The first heating circuit and the second heating circuit can be configured with different heating chips. In a case that the first heating element and the second heating element are the two mutually independent heating elements, a unified heating circuit can be configured for the first heating element and the second heating element. The unified heating circuit can generate different heating powers on the first heating element and the second heating element while outputting a particular heating voltage.

In a case that the first heating element and the second heating element are the integrated heating element, a unified heating circuit can be configured for the first heating element and the second heating element, or a first heating circuit can be configured for the first heating element and a second heating circuit can be configured for the second heating element. The first heating circuit and the second heating circuit are respectively connected to the first heating element and the second heating element of the integrated heating element.

In an example, the first substrate and the second substrate may be the same or different. The first substrate and the second substrate can be respectively carried in different substrate-carrying units. That is, the first substrate is carried in the first substrate-carrying unit, and the second substrate is carried in the second substrate-carrying unit. In other examples, the first substrate and the second substrate may alternatively be carried in the same substrate-carrying unit and are separated. When the first substrate and the second substrate are the same, the first substrate and the second substrate can be carried in the same substrate-carrying unit.

In an example of this disclosure, the first substrate-carrying unit and the second substrate-carrying unit may be different substrate-carrying units. The substrates carried in different substrate-carrying units can be respectively heated by the first heating element and the second heating element at the same time. For example, the first substrate-carrying unit can be a cartridge, and the second substrate-carrying unit can be another different cartridge. Alternatively, the first substrate-carrying unit can be a substrate strip, and the second substrate-carrying unit can be another substrate strip. The first heating stage of the electronic atomizer may include duration of the heating on the electronic atomizer. In one example, the first heating stage of the electronic atomizer may include a period of time of continuous heating after the electronic atomizer is activated.

Step S12: Reduce the heating power of at least one of the first heating element and the second heating element in a second heating stage of the electronic atomizer, where the second stage is a heating stage following the first stage after the electronic atomizer is activated.

In an example of this disclosure, the second heating stage of the electronic atomizer may be another continuous stage, following the first stage, in the process of heating the electronic atomizer. In the first heating stage of the electronic atomizer, the electronic atomizer can be heated based on stable heating power. In the second heating stage of the electronic atomizer, the electronic atomizer can be heated based on varying power. In the first heating stage in the electronic atomizer, the first heating element and the second heating element can operate at constant heating power, or the first heating element and the second heating element can output heating power based on a constant voltage. Meanwhile, in the first heating stage of the electronic atomizer, the temperatures of both the first heating element and the second heating element can be in a rise trend.

In the second stage, the heating power of at least one of the first heating element and the second heating element can be reduced compared with that in the first stage. Alternatively, in the second stage, the heating power of the first heating element and the heating power of the second heating element are both less than that in the first stage. The first stage can be an initial heating stage in a continuous puffing process of the electronic atomizer. The second stage can be a heating stage, following the first stage, in a continuous puffing process of the electronic atomizer.

In the method provided in the examples of this disclosure, the heating process of the electronic atomizer is divided into stages. In the later stages of the heating process, the heating power of at least one heating element can be reduced. This can reduce the aerosol amount generated the electronic atomizer when a plurality of substrate-carrying units that carry substrates are heated simultaneously, thereby controlling the aerosol amount to reduce the harm to a user while implementing simultaneous heating on the plurality of substrate-carrying units to enhance the puffing taste and experience.

In an aspect, the heating method for the electronic atomizer further includes: obtaining the first temperature change rate of the first heating element and the second temperature change rate of the second heating element in the first heating stage of the electronic atomizer, where in a case that the first temperature change rate is less than a set temperature change threshold, and/or the second temperature change rate is less than the set temperature change threshold, the electronic atomizer enters the second heating stage.

The first heating power of the first heating element in the first stage may be different from or the same as the second heating power of the second heating element in the first stage. Correspondingly, in the first stage, the first temperature change rate of the first heating element and the second temperature change rate of the second heating element may be different. When the first temperature change rate is less than a set temperature change threshold and the second temperature change rate is also less than the set temperature change threshold, information indicating that the electronic atomizer enters the second heating stage is generated. The information indicating that the electronic atomizer enters the second heating stage is used for instructing the electronic atomizer to change the heating power of the first heating element and/or the second heating element.

When the first temperature change rate of the first heating element is less a first temperature change threshold, the temperature of the first heating element tends to be stable. Furthermore, when the second temperature change rate of the second heating element is less than a second temperature change threshold, the temperature of the second heating element tends to be stable. In this case, both the first heating element and the second heating element are in states in which the temperatures are relatively stable, so that the information indicating that the electronic atomizer enters the second heating stage can be generated.

The heating method for the electronic atomizer further includes: in a case that airflow information is detected after the electronic atomizer is activated, the electronic atomizer enters the first heating stage.

In an example of this disclosure, the structure of the electronic atomizer is shown in FIG. 2, including a power supply unit, a voltage control unit, a micro controller unit (MCU), a memory, a first heating control unit, a second heating control unit, a first heating element, and a second heating element. The power supply unit is configured to supply power to the voltage control unit, the MCU, the memory, the first heating control unit, the second heating control unit, the first heating element, and the second heating element. The MCU is configured to control the first heating control unit and the second heating control unit. The memory is configured to store data such as parameters and thresholds that are required by the MCU. In a possible implementation, the power supply unit may include an airflow sensor, the power supply unit supplies power based on airflow information detected by the airflow sensor. Meanwhile, when a user continuously takes a puff on the electronic atomizer, the airflow sensor can continuously detect continuous airflow information, thereby starting to supply power based on the first heating power of the first heating element and the second heating power of the second heating element in the first stage.

In an aspect, the using a first heating element to heat a first substrate-carrying unit of the electronic atomizer, and using a second heating element to heat a second substrate-carrying unit of the electronic atomizer includes: using the first heating element to heat the first substrate-carrying unit continuously for first period of time at first heating power; and using the second heating element to heat the second substrate-carrying unit continuously for second period of time at second heating power.

In an aspect, the first heating element and the second heating element can be tested in advance to obtain approximate time required for causing the temperature of the first heating element to tend to be stable at the first heating power, and approximate time required for causing the temperature of the second heating unit to tend to be stable at the second heating power. First period of time is determined based on the approximate time required for causing the temperature of the first heating element to tend to be stable at the first heating power, and second period of time is determined based on the approximate time required for causing the temperature of the second heating element to tend to be stable at the second heating power. In the initial heating stage, the first heating element and the second heating unit are heated by using relatively high heating power. Generally, in the initial heating stage, the aerosols do not quickly fill an airflow channel, possibly because a user cannot inhale aerosols immediately. In the initial heating stage, using high power for heating makes the temperature of a heating element to rapidly rise. It helps shorten the waiting time of the user. In the second stage, after the temperatures of the heating elements (including the first heating element and the second heating element) are stabilized, the aerosol amount is ingeniously effectively limited in a manner of alternately heating the heating elements. This approach not only meets a need of a user for the aerosol amount, but also avoids a health risk caused by excessive aerosols.

In an aspect, after the electronic atomizer is activated, the temperatures of the first heating element and the second heating unit are relatively low. In a puffing interval of a user, the temperature of the first heating element and the temperature of the second heating unit are higher than those at a first puff after the electronic atomizer is activated. Therefore, after the electronic atomizer is activated, when the user takes the first puff, the first heating element is heated until the temperature tends to be stable. It takes longer time than the time required for heating the first heating element until the temperature tends to be stable after the first puff. Therefore, after the electronic atomizer is activated, when the user takes the first puff, the second heating unit is heated until the temperature tends to be stable. It takes longer time than the time required for heating the second heating unit until the temperature tends to be stable after the first puff. Correspondingly, the first period of time can include a plurality of time values, and the second period of time can include a plurality of time values as well. The first period of time and the second period of time correspond to, after the electronic atomizer is activated, the heating time of the first stage in the first puff and the heating time of the first stage after the first puff. The duration of the first stage is greater than or equal to the maximum time of the first period of time and the second period of time in a current puffing process.

In an aspect, real-time temperature measurement can be performed on the first heating element and the second heating element in the first stage. When it is determined via measurement that the temperature of the first heating element reaches the first temperature threshold, it is determined that the temperature of the first heating element tends to be stable, meaning that the temperature change rate is less than a temperature change rate corresponding to the first temperature threshold. In addition, when it is determined via measurement that the temperature of the second heating element reaches the second temperature threshold, it is determined that the temperature of the second heating element tends to be stable, meaning that the temperature change rate is less than a temperature change rate corresponding to the second temperature threshold. Subsequently, the information indicating that the electronic atomizer enters the second heating stage is generated.

In an aspect, the first heating power is the maximum power of the first heating element; and/or the second heating power is the maximum power of the second heating element. In a possible implementation, if the first heating power is greater than the second heating power, the first heating duration for the first heating element in the first stage is greater than the second heating duration for the second heating element in the first stage.

In an aspect, the first heating power may be N1 times the maximum power of the first heating element. The second heating power may be N2 times the maximum power of the second heating element. N1 and N2 may be 90% to 100%.

In an aspect, the reducing the heating power of at least one of the first heating element and the second heating element in a second heating stage of the electronic atomizer includes: in a third stage, using the first heating element to heat the first substrate-carrying unit at the third heating power, and using the second heating element to heat the second substrate-carrying unit at the fourth heating power, where the second stage includes the third stage (e.g., first sub heating stage); the third heating power is less than the fourth heating power; and the fourth heating power is less than or equal to the second heating power.

In an aspect, after the third stage, other powers can be used to heat the first substrate-carrying unit in other stages. Furthermore, after the third stage, other powers can be used to heat the second substrate-carrying unit in other stages. After the other stages of heating the electronic atomizer are completed, the third stage can be re-executed. In the continuous heating process, different heating stages (such as the third stage and the fourth stage) can be alternately implemented. For example, after the third stage, the fourth stage (e.g., second sub heating stage) of heating of the electronic atomizer is executed. In the fourth stage, the first heating element is used to heat the first substrate-carrying unit at fifth heating power, and the second heating element is used to heat the second substrate-carrying unit at the sixth heating power.

In the third stage, more powers can be outputted to the second heating element, so that the electronic atomizer mainly heats the second substrate-carrying unit and assists in heating the first substrate-carrying unit. Therefore, at least two different substrates in two different substrate-carrying units can be simultaneously atomized, to generate mixed aerosols and provide a user with a mixed mouth feel during a puff.

In an aspect, the duration of the third stage is shorter than the duration of the first stage. Since the duration of the third stage is relatively short, the temperature drop of the first heating element is controlled. When the aerosol amount generated by the substrate in the first substrate-carrying unit is reduced, the substrate in the first substrate-carrying unit can be heated at a relatively low temperature, so that aerosols obtained by atomizing the substrate in the first substrate-carrying unit can be mixed with aerosols obtained by atomizing the substrate in the second substrate-carrying unit, to maintain a mixed mouth feel.

In an aspect, the third heating power may be 0. In this case, the substrate in the first substrate-carrying unit is not atomized.

In an aspect, the reducing the heating power of at least one of the first heating element and the second heating element in a second heating stage of the electronic atomizer includes: in the fourth stage, using the first heating element to heat the first substrate-carrying unit at fifth heating power, and using the second heating element to heat the second substrate-carrying unit at sixth power, where the second stage includes the fourth stage; the fifth heating power is greater than the sixth heating power; and the fifth heating power is less than or equal to the first heating power.

In the fourth stage, more powers can be outputted to the first heating element, so that the electronic atomizer mainly heats the first substrate-carrying unit and assists in heating the second substrate-carrying unit. Therefore, at least two different substrates in two different substrate-carrying units can be simultaneously atomized, to generate mixed aerosols and provide a user with a mixed mouth feel during a puff.

In an aspect, the duration of the fourth stage is shorter than the duration of the first stage.

In an aspect, the sixth heating power may be 0. In this case, the substrate in the second substrate-carrying unit is not atomized. By controlling the value of the third heating power to the value of the sixth heating power, a substrate that is atomized in one puff has a set weight, for example, 5 milligrams to 50 milligrams. Further, the set weight may be 10 milligrams to 20 milligrams, such as 10 milligrams.

In an aspect, the second stage, the third stage, and the fourth stage may be repeatedly alternated in the continuous heating process of one puff. For example, after the first stage ends, the third stage can start. After the third stage ends, the fourth stage can start. After the fourth stage ends, the third stage can start again. This process is repeated in this way until this puff ends. Alternatively, after the first stage ends, the fourth stage can start. After the fourth stage ends, the third stage can start. After the third stage ends, the fourth stage can start again. This process is repeated in this way until a current puff ends. Therefore, when one heating element of the electronic atomizer is in a heating state, the other heating element does not completely stop working, but continues to operate in a low-power preheating manner. This design not only avoids significant fluctuations in the temperatures of the heating elements, but also ensures a more uniform and stable heating process of e-liquid, thus significantly enhancing the quality of flavors of aerosols and providing a user with a finer and richer taste experience.

In an aspect of this disclosure, the electronic atomizer may be possibly provided with more heating elements. A plurality of different heating elements can heat the substrates of different substrate-carrying units in the same puff, thus generating a richer mixed mouth feel. In a continuous heating process of the same puff using two or more heating elements, when the substrates of the plurality of substrate-carrying units are heated, it is also possible to heat, in the first stage, the plurality of heating elements to a state in which the temperatures basically tend to be stable. Then, the second stage is executed: heating at least one of the plurality of heating elements based on reduced power, and keeping the heating powers of other heating elements being reduced or unchanged, thus achieving a mixed mouth feel and enhancing the health performance of the electronic atomizer. Through some tests, it has been found that a low heating frequency may produce relatively higher noises for some types of substrates.

However, an extremely high heating frequency can produce an undesirable burnt flavor. In this embodiment of this disclosure, in a case that the maximum heating power of the first heating element is greater than the maximum heating power of the second heating element, the duration of the third stage is shorter than the duration of the fourth stage. By dynamically adjusting the heating frequency, the noises in the heating process of the heating substrates can be reduced, and the stability of aerosol generation and the flavor superiority can be ensured.

In an example of this disclosure, a first heating circuit (equivalent to the first heating element of the foregoing embodiment) is used to heat the first heating element, and a second heating circuit (equivalent to the second heating element of the foregoing embodiment) is used to heat the second heating element. The maximum heating power of the first heating circuit is recorded as Pa (e.g. 2 to 8 W), and the maximum heating power of the second heating circuit is recorded as Pb (2 to 8 W), Pa≥Pb.

In the first puff process of the electronic atomizer, in the first stage, after the airflow information is detected, both the first heating circuit and the second heating circuit perform heating at their maximum heating powers. The heating duration for the first heating element is recorded as t1, and the heating duration for the second heating element is recorded as t2. In the fourth stage of the second stage, the first heating element can be first heated at relatively high power, and the heating power of the second heating element is reduced, so that the sixth heating power of the second heating element is less than the second heating power of the second heating element in the first stage, and this continues for duration of t3. In the third stage of the second stage, the second heating element can be then heated with increased power, and the heating power of the first heating element is reduced, so that the third heating power of the first heating element is less than the first heating power of the first heating element in the first stage, and this continues for duration of t4. The fourth stage and the third stage are cycled in the second stage until this puff ends, and the heating on the first heating element and the second heating element is stopped.

The heating time t1 and the heating time t2 may be duration from the start of the heating of the heating elements to the time required for reaching stable working temperature values, which is approximately 0.1 s to 2 s, and further, can be 0.5 s to 1.3 s. The heating time t3 and the heating time t4 may be duration during which the stable working temperature values decrease until the e-liquid does not evaporate or the evaporation amount is very small, which is approximately 10 ms to 500 ms, and further, can be 50 ms to 300 ms.

Under normal circumstances, t1≥t2>t3≥t4. In the third stage and the fourth stage, the atomization amount of a substrate corresponding to a heating element with relatively low power will be significantly reduced. The heating power of the heating element decreases or may decrease after the heating is stopped, until no aerosols are generated or until the aerosol amount reaches a relatively small set value.

In an aspect, in the second stage, the temperatures of both the first heating element and the second heating element are measured in real time, and the heating power for the first heating element and the heating power for the second heating element are determined based on the temperatures.

Corresponding relationships between the atomization amounts of the substrates in the third stage and the fourth stage and the heating powers for the heating elements can be measured in advance. Based on the corresponding relationships between the atomization amounts of the heating elements and the heating powers, the heating powers and the durations that respectively correspond to the first heating element and the second heating element in the third stage and the fourth stage can be determined. Alternatively, corresponding relationships between the atomization amounts of the substrates in the third stage and the fourth stage and the temperatures of the heating elements can be measured in advance to determine the temperatures and the durations that respectively correspond to the first heating element and the second heating elements in the third stage and the fourth stage. The temperatures of the first heating element and the second heating element can be measured in real time in the third stage and the fourth stage to control the first heating element and the second heating element at set temperatures.

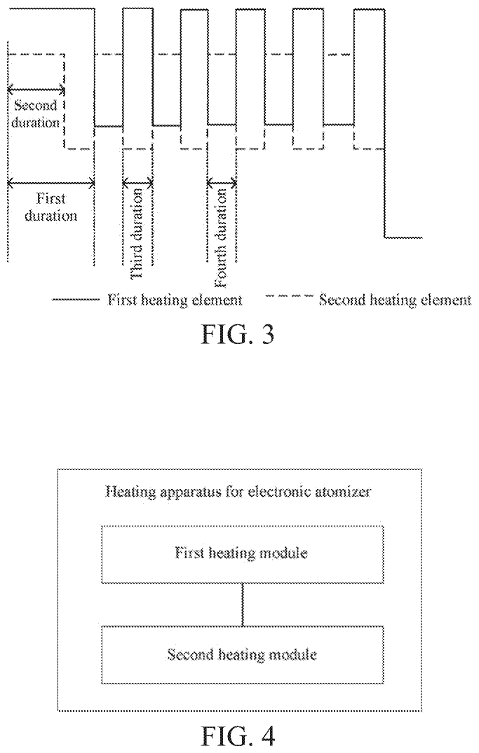

In an aspect of this disclosure, a relationship between the heating power of the first heating element and the heating power of the second heating element in the first stage and the second stage is shown in FIG. 3. In the first stage, the first heating power of the first heating element is greater than the second heating power of the second heating element, and the first duration of the first heating element is greater than the second duration of the second heating element. The second stage is executed after the first heating element stops heating. In the third stage, the third heating power of the first heating element is less than the fourth heating power of the second heating element for third duration, and the fourth heating power of the second heating element is equal to the second heating power. In the fourth stage, the fifth heating power of the first heating element is less than the sixth heating power of the second heating element for fourth duration, and the fifth heating power of the first heating element is equal to the first heating power. In the example shown in FIG. 3, the heating powers of the first heating element and the second heating element are changed in a sudden change manner. In other possible implementations, the heating powers of the first heating element and the second heating element can be changed in a gradual change manner. For example, the heating power of the first heating element and/or the second heating element can be changed in a linear change manner in at least one of the first stage, the third stage, and the fourth stage. The heating power of the first heating element and/or the second heating element can be changed in a curve change manner such as sine or cosine in at least one of the first stage, the third stage, and the fourth stage.

An aspect of this disclosure further provides a heating apparatus for an electronic atomizer, as shown in FIG. 4, including: a first heating module and a second heating module.

The first heating module is configured to: in a first heating stage of the electronic atomizer, use a first heating element to heat a first substrate-carrying unit of the electronic atomizer, and use a second heating element to heat a second substrate-carrying unit of the electronic atomizer. The second heating module is configured reduce the heating power of at least one of the first heating element and the second heating element in a second heating stage of the electronic atomizer, where the second stage is a heating stage following the first stage after the electronic atomizer is activated.

In an aspect, the heating apparatus for the electronic atomizer further includes: a first stage detection module configured to obtain the first temperature change rate of the first heating element and the second temperature change rate of the second heating element in the first heating stage of the electronic atomizer; and a second stage execution module configured to generate, in a case that the first temperature change rate is less than a set temperature change threshold, and/or the second temperature change rate is less than the set temperature change threshold, information indicating that the electronic atomizer enters the second heating stage.

In an aspect, the heating apparatus for the electronic atomizer further includes: a first stage execution module configured to generate, in a case that airflow information is detected after the electronic atomizer is activated, information indicating that the electronic atomizer enters the first heating stage.

In an aspect, the first heating module includes: a first heating element configured to use the first heating element to heat the first substrate-carrying unit continuously for first period of time at first heating power; and a second heating unit configured to use the second heating element to heat the second substrate-carrying unit continuously for second period of time at second heating power.

In an aspect, the first heating power is the maximum power of the first heating element; and/or the second heating power is the maximum power of the second heating element.

In an aspect, the second heating module includes a third stage heating unit configured to: in a third stage, use the first heating element to heat the first substrate-carrying unit at the third heating power, and use the second heating element to heat the second substrate-carrying unit at the fourth heating power, where the second stage includes the third stage; the third heating power is less than the fourth heating power; and the fourth heating power is less than or equal to the second heating power.

In an aspect, the duration of the third stage is shorter than the duration of the first stage.

In an aspect, the second heating module includes: a third stage heating unit configured to: in the fourth stage, use the first heating element to heat the first substrate-carrying unit at fifth heating power, and use the second heating element to heat the second substrate-carrying unit at sixth power, where the second stages includes the fourth stage; the fifth heating power is greater than the sixth heating power; and the fifth heating power is less than or equal to the first heating power.

In an aspect, the duration of the fourth stage is shorter than the duration of the first stage.

An aspect of this disclosure further provides an electronic device. The electronic device includes processing circuitry, such as a processor and a memory. The memory is configured to: store a program causing the electronic device to perform the method provided in any embodiment of this disclosure, and store data for implementing the method provided in any embodiment of this disclosure. The processor is configured to perform the program stored in the memory.

The present disclosure are a combination of elements and features of the present invention. Unless otherwise stated, the elements or features may be considered selective. Each element or feature can be practiced without being combined with other elements or features. In addition, the implementations of the present invention can be constructed by combining some elements and/or features. An order of operations described in the implementations of the present invention can be rearranged. Some constructions of any implementation may be included in another implementation and may be replaced by corresponding constructions of another implementation. For those skilled in the art, it is obvious that claims without clear reference to each other in the attached claims can be combined into the implementations of the present invention, or can be used as new claims in modifications after submission of the present invention.

In the firmware or software configuration means, the implementations of the present invention can be implemented in the form of modules, processes, functions, and the like. Software codes can be stored in a memory unit and executed by a processor. The memory unit is located inside or outside the processor and can send data to and receive data from the processor through various known measures.

The aspects of the system and method described herein can be implemented as functions programmed into any of various circuits. These circuits a programmable logic device (PLD) such as a field programmable gate array (FPGA), a programmable array logic (PAL) device, an electronic programmable logic and storage device, a standard unit based device, and an application specific integrated circuit (ASIC). Some other possibilities for implementing these aspects of the system include: a microcontroller with a memory, such as an electronically erasable programmable read-only memory (EEPROM), an embedded micro processing unit, firmware, and software. In addition, these aspects of the system can be reflected in a micro processing unit with a software-based circuit simulation, a discrete logic (sequence and combination), a customized device, a fuzzy (neural) logic, a quantum device, and any combination of the various types of devices mentioned above. Certainly, underlying device technologies can be provided in various component types, such as a metal oxide semiconductor (such as a complementary metal oxide semiconductor (CMOS)) field-effect transistor (MOSFET) technology, a bipolar technology such as an emitter-coupled logic (ECL), a polymer technology (such as a silicon conjugated polymer and metal conjugated polymer metal structure), and hybrid simulation and digitalization.

The various functions or processes disclosed herein can be described as data and/or instructions embodied in various computer-readable substrates based on their behaviors, register transmission, logic components, transistors, geometric layouts, and/or other features. The computer-readable media that may contain such formatted data and/or instructions include but are not limited to various forms of non-volatile storage media (such as optical, magnetic, or semiconductor storage media) and carrier waves, which can be configured to transmit such formatted data and/or instructions through wireless, optical, or wired signal media or any combination thereof. When being received to any one of various circuits (such as a computer), such data and/or instructions can be processed by a processing entity (such as one or more processors).

The above descriptions of the illustrated embodiments of the system and method are not intended to be exhaustive or to limit the system and method to the precise forms disclosed. Although the specific embodiments and examples of the system, the components, and the method are described herein for illustrative purposes, those skilled in the art should understand that various equivalent modifications can be made within the scope of the system, the components, and the method. The teachings of the system and method that are provided herein can be applied to other processing systems and methods, not just to the foregoing system and the foregoing method.

A person skilled in the art can understand that various changes and/or modifications can be made to the present invention shown in the specific embodiments without departing from the spirit or scope widely described in the present invention. Therefore, this embodiment will be considered illustrative rather than restrictive in all aspects. In addition, the present invention includes any combination of features described for different embodiments (including the feature in the abstract section), even if the feature or the combination of the features are not explicitly stated in the claims or detailed description of this embodiment.

Generally, the terms used in the following claims should not be interpreted as limiting the system and the method to the specific embodiments disclosed in the specification and the claims, but should be interpreted as including all processing systems operated in the claims. Therefore, the system and the method are not limited by the present disclosure, but the scopes of the system and the method are completely determined by the claims.

Unless otherwise explicitly required by the context, terms such as “include” and “including” should be interpreted in their inclusive meanings throughout the entire specification and claims, rather than in their exclusive or exhaustive meanings. That is, they are explained by the meaning of “including but not limited to”. The use of a singular or plural word also includes a singular or plural meaning. In addition, “herein”, “the following”, “above”, “below”, and terms with similar meanings refer to the entire present disclosure, rather than any specific part of this disclosure. When the term “or” is used for a list involving two or more items, the term “or” includes all interpretations of the term: any item in the list, all items in the list, and any combination of items in the list.

In addition, the terms “first” and “second” are used for descriptive purposes only and are not to be construed as indicating or implying relative importance or to implicitly indicate the number of technical features indicated. From this, features defined as “first” and second” may explicitly or implicitly include one or more features. In the descriptions of this disclosure, “a plurality of” means more than two, unless otherwise definitely and specifically limited.

The foregoing descriptions are merely preferred embodiments of this disclosure, but are not intended to limit this disclosure. Any modification, equivalent replacement, or improvement made within the spirit and principle of this disclosure shall fall within the protection scope of this disclosure.

What is claimed is:

1. A heating method comprising:
heating an electronic atomizer in a first heating stage, the electronic atomizer including a first heating element and a second heating element to heat a substrate; and
reducing a heating power of at least one of the first heating element and the second heating element in a second heating stage.

2. The method of claim 1, wherein
the substrate comprises a first substrate and a second substrate; and
in the first heating stage,
the first heating element heats the first substrate, and
the second heating element heats the second substrate.

3. The method of claim 2, wherein
the first substrate is in a first substrate-carrying unit of the electronic atomizer, and
the second substrate is in a second substrate-carrying unit of the electronic atomizer.

4. The method of claim 1, further comprising:
obtaining a first temperature change rate of the first heating element in the first heating stage;
obtaining a second temperature change rate of the second heating element in the first heating stage; and
the electronic atomizer entering the second heating stage, when
the first temperature change rate is less than a threshold, and/or
the second temperature change rate is less than the threshold.

5. The method of claim 1, further comprising:
entering the first heating stage when a puff is detected.

6. The method of claim 1, further comprising:
heating, using the first heating element, the substrate for a first period of time at a first heating power; and
heating, using the second heating element, the substrate for a second period of time at a second heating power.

7. The method of claim 6, wherein
the first heating power is a maximum power of the first heating element; and/or
the second heating power is a maximum power of the second heating element.

8. The method of claim 5, the second heating stage further comprising:
a first sub heating stage, using the first heating element to heat the substrate at a third heating power, and
the first sub heating stage, using the second heating element to heat the substrate at a fourth heating power, wherein
the third heating power is less than the fourth heating power, and
the fourth heating power is less than or equal to the second heating power.

9. The method of claim 8, wherein a duration of the first sub heating stage is shorter than a duration of the first heating stage.

10. The method of claim 8, the second stage further comprising:
a second sub heating stage after the first sub heating stage;
in the second sub heating stage, using the first heating element to heat the substrate at fifth heating power, and using the second heating element to heat the substrate at the sixth heating power, wherein the fifth heating power is greater than the sixth heating power, and the fifth heating power is less than or equal to the first heating power; and
returning to the first sub heating stage after the second sub heating stage is completed.

11. The method of claim 10, wherein a duration of the second sub heating stage is shorter than a duration of the first stage.

12. An electronic device comprising:
processing circuitry configured to
heat an electronic atomizer in a first heating stage, the electronic atomizer including a first heating element and a second heating element to heat a substrate; and
reduce a heating power of at least one of the first heating element and the second heating element in a second heating stage.

13. The electronic device of claim 12, wherein
the substrate comprises a first substrate and a second substrate; and
in the first heating stage,
the first heating element heats the first substrate, and
the second heating element heats the second substrate.

14. The electronic device of claim 13, wherein
the first substrate is in a first substrate-carrying unit of the electronic atomizer, and
the second substrate is in a second substrate-carrying unit of the electronic atomizer.

15. The electronic device of claim 12, wherein the processing circuitry is configured to:
obtain a first temperature change rate of the first heating element in the first heating stage;
obtain a second temperature change rate of the second heating element in the first heating stage; and
enter the second heating stage, when
the first temperature change rate is less than a threshold, and/or
the second temperature change rate is less than the threshold.

16. The electronic device of claim 12, wherein the processing circuitry is configured to:
enter the first heating stage when a puff is detected.

17. The electronic device of claim 12, wherein the processing circuitry is configured to:
heat, using the first heating element, the substrate for a first period of time at a first heating power; and
heat, using the second heating element, the substrate for a second period of time at a second heating power.

18. The electronic device of claim 17, wherein
the first heating power is a maximum power of the first heating element; and/or
the second heating power is a maximum power of the second heating element.

19. The electronic device of claim 16, wherein the second heating stage further comprises:
a first sub heating stage, using the first heating element to heat the substrate at a third heating power, and
the first sub heating stage, using the second heating element to heat the substrate at a fourth heating power, wherein
the third heating power is less than the fourth heating power, and
the fourth heating power is less than or equal to the second heating power.

20. The electronic device of claim 19, wherein a duration of the first sub heating stage is shorter than a duration of the first heating stage.
